(19) United States
(12) Patent Application Publication
(10) Pub. No.: US 2018/0367591 A1
(43) Pub. Date: Dec. 20, 2018

(54) SYNCHRONIZING SEGMENT BOUNDARIES ACROSS MULTIPLE STREAMS

(71) Applicant: Edgeware AB, Stockholm (SE)

(72) Inventors: Patrik ALM, Danderyd (SE); Ola Bengtsson, Huddinge (SE)

(73) Assignee: Edgeware AB, Stockholm (SE)

(21) Appl. No.: 16/061,303

(22) PCT Filed: Oct. 17, 2016
(86) PCT No.: PCT/SE2016/051003

§ 371 Date: Jun. 11, 2018

(30) Foreign Application Priority Data
Nov. 10, 2015 (SE) 1551456-5

(51) Int. Cl. H04L 29/06; H04N 21/2343; H04N 21/242; H04N 21/845; H04N 21/8547

(52) U.S. Cl. CPC H04L 65/605; H04N 21/23439; H04N 21/8547; H04N 21/8456; H04N 21/242

(57) ABSTRACT

Provided are methods and streaming servers for segmenting multiple received content streams, and for aligning created segments of received content stream at a master server with segments of the received content streams created by a slave server. An example method performed at a streaming server of segmenting at least two received content streams is provided. The method comprises identifying a current boundary point for each of the at least two received content streams indicating where the respective content stream can be segmented, determining whether an identifier for a segment is included in a segment information database at the streaming server, the identified segment having a starting point corresponding to a timestamp of the identified current boundary point, and if so segmenting the received content stream, for which the segment identifier was included in the segment information database, at the timestamp and including the segment identifier with the segmented stream.

### TECHNICAL FIELD

The invention relates to a method of segmenting at least two received content streams, and a streaming server performing the method.

The invention further relates to a master server and a method performed at the master server of aligning created segments of received content streams with segments of the received content streams created by a slave server

Moreover, the invention relates to a slave server and a method performed at the slave server of aligning created segments of received content streams with segments of the received content streams created by a master server.

### BACKGROUND

When streaming content over a network, a technique known as Adaptive Bitrate Streaming (ABS) is commonly used. In ABS, the same content to be streamed is encoded at different bitrates and segmented into data sets known as segments.

In other implementations, a video stream may be provided at different resolutions, or an audio stream may be provided in different languages, which streams need to be segmented as in the example of ABS.

Thus, in the example of ABS, the segments comprise the content at different streaming quality levels depending on the bitrate at which the content initially was encoded.

A client can subsequently switch between the different segments; if the client has capacity to stream a higher-quality segment, it can request to do so whereas if the capacity of the client should decrease, it can switch to a lower-quality segment. Typically, the client reads a so called manifest file stored at a streaming server, where the different segments and their associated quality is identified.

In ABS, the segments of different quality levels must correspond to the same piece of the content, to allow a client to switch between segments without experiencing a gap in the rendered content or a content overlap. This requires segmentation to be aligned across all quality levels available to a streaming server supplying the client with the content.

For redundancy, the same content streams are typically sent to multiple streaming servers. In such a scenario, it is then crucial that the segmentation and identification of segments are aligned across the multiple streaming servers, to allow clients to perform failover to another server during a streaming session.

### SUMMARY

An object of the present invention is to solve, or at least mitigate, these problems in the art and to provide aligning of segments pertaining to separate content streams, as well as aligning of segments over multiple servers.

This object is attained in a first aspect of the invention by a method performed at a streaming server of segmenting at least two received content streams. The method comprises identifying a current boundary point for each of the at least two received content streams indicating where the respective content stream can be segmented, determining whether an identifier for a segment is included in a segment information database at the streaming server, the identified segment having a starting point corresponding to a timestamp of the identified current boundary point, and if so segmenting the received content stream, for which the segment identifier was included in the segment information database, at the timestamp and including the segment identifier with the segmented stream.

This object is attained in a second aspect of the invention by a streaming server configured to segment at least two received content streams. The streaming server comprises a processing unit arranged to cause the streaming server to be operative to identify a current boundary point for each of the at least two received content streams indicating where the respective content stream can be segmented, determine whether an identifier for a segment is included in a segment information database at the streaming server, the identified segment having a starting point corresponding to a timestamp of the identified current boundary point, and if so to segment the received content stream, for which the segment identifier was included in the segment information database, at the timestamp and including the segment identifier with the segmented stream.

Advantageously, by using a boundary point of a first received content stream as reference for segmenting the first content stream at subsequent boundary points, as well as for segmenting further received content streams at encountered boundary points, the created segments of the received streams of the streaming server are aligned.

In an embodiment of the invention, one of the at least two received content streams is advantageously initially segmented at a starting timestamp for creating a segment with which the other received content streams can be synchronized.

In a further embodiment, in case no identified segment in the segment information database has a starting point corresponding to a timestamp of the identified current boundary point, the streaming server determines whether the timestamp of the identified current boundary point indicates an allowable segment length, and if so segments the received content stream, for which the segment length is indicated to be allowable, at the timestamp and including the segment identifier with the segmented stream, and updating the segment information database. Advantageously, a predefined allowable length is set, which the predefined length the streaming server will account for when performing the segmenting of received content streams.

In an embodiment, the streaming server performs the updating of the segment information database by adding an incremented segment identifier and setting a starting point of the segment corresponding to the incremented identifier to the time stamp of the identified current boundary.

Advantageously, the segment information database is continuously updated as new segments are created on the basis of encountered boundary points, thereby maintaining the alignment of the segments pertaining to the different received content streams.

In still another embodiment, when the streaming server determines whether the timestamp of the identified current boundary point indicates an allowable segment length, the server further determines whether a difference in time between the time stamp of the identified current boundary point and a starting point of a closest previously identified segment exceeds a minimum allowable segment length, and if not precludes the time stamp of the identified current boundary point as a possible segmenting point. Advantageously, if the streaming server concludes that the difference in timestamp does not exceed a minimum length, the identified current boundary point is skipped as possible segmenting point.

In a further embodiment, in case the difference in time between the timestamp of the identified current boundary point and a starting point of a closest previous identified segment exceeds a minimum allowable segment length, the streaming server determines whether a difference in time between the timestamp of the identified boundary point and a starting point of a closest previously identified segment is less than a maximum allowable segment length, and if not resynchronizes to one of the received content streams. Advantageously, if the streaming server concludes that the difference in timestamp exceeds a maximum length, the boundary point where segmenting should have been performed has passed, and the segments are no longer aligned; the streaming server will thus resynchronize to a content stream and start over with creating a new segment information database.

This object is attained in a third aspect of the invention by a method performed at a master server of aligning created segments of received content streams with segments of received content streams created by a slave server. The method comprises providing the slave server with a current segment information database comprising at least an identifier for a segment and a starting point for each identified segment.

This object is attained in a fourth aspect of the invention by a master server configured to align created segments of received content streams with segments of received content streams created by a slave server. The master server comprises a processing unit arranged to cause the master server to be operative to provide the slave server with a current segment information database comprising at least an identifier for a segment and a starting point for each identified segment.

This object is attained in a fifth aspect of the invention by a method performed at a slave server of aligning created segments of received content streams with segments of the received content streams created by a master server. The method comprises acquiring, from the master server, a current segment information database comprising at least an identifier for a segment and a starting point for each identified segment.

This object is attained in a sixth aspect of the invention by a slave server configured to align created segments of received content streams with segments of the received content streams created by a master server. The slave server comprises a processing unit arranged to cause the slave server to be operative to acquire, from the master server, a current segment information database comprising at least an identifier for a segment and a starting point for each identified segment.

In embodiments, the current segment information database is provided to, or acquired by, the slave server upon start-up, and in case resynchronization is required at the slave server or the master server, a more current segment information database is provided to, or acquired by, the slave server.

Advantageously, the slave server is initially synchronized with the master server in that the slave server is provided with the segment information database from which it initially can start creating segments. Thereby, segments of the slave server will advantageously be aligned with the segments of the master server. After the slave server is provided with the segment information database, it will proceed with creating segments as has been discussed in detail hereinabove in embodiments pertaining to the first and second aspect of the invention.

The master server generally performs, upon providing the segment information database to the slave server, one or more or all of the embodiments discussed above with reference to the first and second aspects of the invention. Further, the slave server performs, after having acquired the segment information database from the master server, one or more or all of the embodiments discussed above with reference to the first and second aspects of the invention, but generally not the embodiment of initially segmenting one of the at least two received content streams at a starting timestamp for creating a segment with which the other received content streams can be synchronized, since this is performed by the master server and is reflected in the segment information database provided to the slave server.

In a further aspect of the invention, computer programs are provided comprising computer-executable instructions for causing the servers to perform steps recited in the methods of the invention when the computer-executable instructions are executed on processing units included in the servers.

In yet a further aspect of the invention, computer program products are provided comprising computer readable media, the computer readable media having the computer programs embodied thereon.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 shows a Content Distribution Network (CDN) in which streaming servers according to embodiments of the invention may be implemented.

FIG. 2 illustrates four different profiles, segmented into 12 different segments, and segments selected by a client;

FIG. 3 illustrates two content profiles each segmented at a streaming server into three segments according to an embodiment of the invention;

FIG. 4 illustrates a flowchart of a method performed at a streaming server of segmenting at least two received content streams according to an embodiment of the invention.

FIG. 5 illustrates a flowchart of a method performed at a streaming server of segmenting at least two received content streams according to a further embodiment of the invention;

FIG. 6 illustrates a flowchart of a method of a further embodiment of the invention for determining whether a timestamp of a currently identified boundary point indicates an allowable segment;

FIG. 7 illustrates a further embodiment of the invention where not only one streaming server is used, but at least one further server for providing a client with requested content;

FIG. 8 illustrates an embodiment of the invention, where a first server is assigned the task of a master server, while a second server is assigned the task of a slave server;

FIG. 9 illustrates another embodiment of the invention, where a first server is assigned the task of a master server, while a second server is assigned the task of a slave server;

FIG. 10 illustrates a flowchart of a method performed at a slave server of segmenting at least two received content streams, where a segment information database is acquired from a master server upon start-up; and

FIG. 11 illustrates a streaming server according to an embodiment of the invention.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

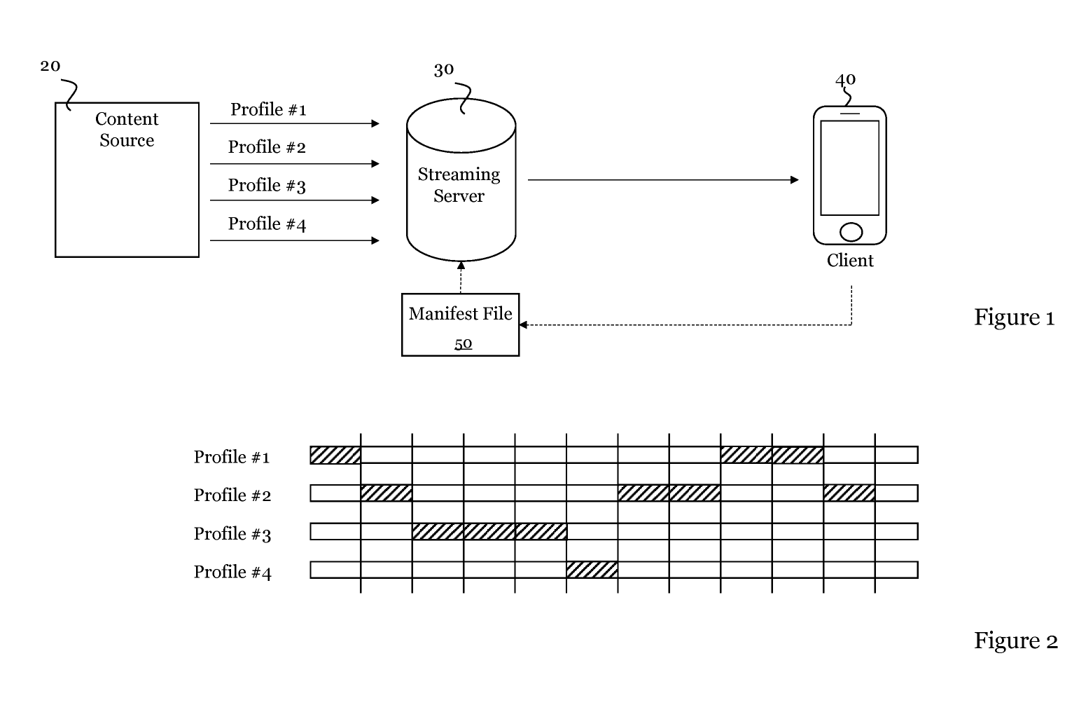

FIG. 1 shows a simplified Content Distribution Network (CDN) 10 delivering content to a client 40. A content source 20 delivers content such as a motion picture for the client to stream. As previously mentioned, when utilizing Adaptive Bitrate Streaming (ABS), the same content is encoded by the content source 20 at different bitrates commonly referred to as profiles. In FIG. 1, this is illustrated in that four different profiles may be selected via a streaming server 30.

In other implementations, a video stream may be provided at different resolutions, or an audio stream may be provided in different languages, which streams need to be segmented as in the example of ABS. In the following, the different profiles will be exemplified as content encoded at different bitrates.

The streaming server 30 receives the four different profiles and divides the corresponding content into data sets known as segments. The segments hence comprise the content at different bitrates. The client 40 can subsequently switch between the different segments, since corresponding segments of different profiles are equally-sized; if the client has capacity to stream a higher-quality segment, it can request to do so whereas if the capacity of the client 40 should decrease, it can switch to a lower-quality segment. Typically, the client reads a so called manifest file 50 stored at a streaming server 30, where the different segments and their associated quality/bitrate is identified.

FIG. 2 illustrates four different profiles, i.e. content encoded at four different bitrates. The content is segmented into 12 different segments. In this particular example, as is indicated with striped segments the client 40 selects Profile #1 for Segment #1, Profile #2 for Segment #2, Profile #3 for Segments #3-5, Profile #4 for Segment #6, and so on.

The format of the content streams received at the streaming server 30 from the content source 20 could for instance include MPEG-2 (“Moving Picture Experts Group 2”) transport streams (TS) over separate multicast feeds, with synchronized timelines and reference frames. The format of the segmented streams output from the streaming server 30 to the client 40 may include Apple HLS (“Hypertext Transfer Protocol Live Streaming”), Microsoft Smooth, MPEG DASH (“Dynamic Adaptive Streaming over HTTP”), etc.

In ABS, the segments of different profiles must correspond to the same piece of the content to allow a client to switch between segments without experiencing a gap in the rendered content or a content overlap. This requires segmentation to be aligned across all profiles available to the streaming server 30 supplying the client 40 with content from the content source 20.

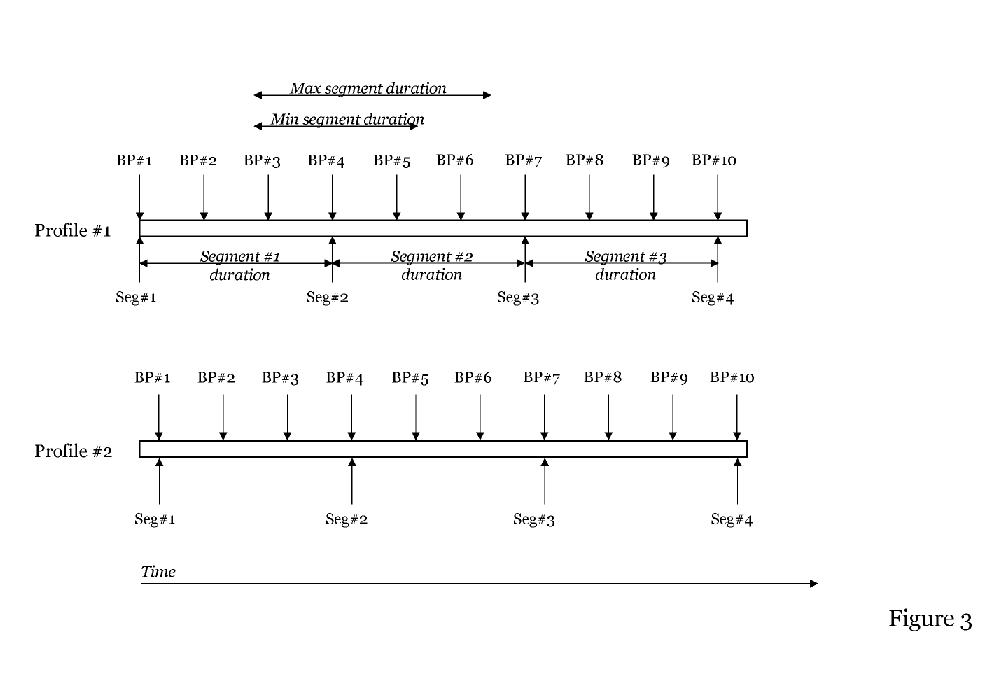

FIG. 3 illustrates two content profiles each segmented at the streaming server 30 into three segments. At the content source 20, markers known as boundary points (BP) are interspersed into the content to indicate to the streaming server 30 points in time where the content streams can be segmented. Hence, each BP is associated with a timestamp. Boundary points known in the art are e.g. the encoder boundary points described in OpenCable specification “Encoder Boundary Point Specification”, or the so called random access indicators used in MPEG-2.

Now, as is illustrated in FIG. 3, Profile #1 and Profile #2 are not aligned when received at the server 30. That is, the two content streams are slightly shifted in time with respect to each other. The client 40 will request desired segments by consulting the manifest file 50 of the streaming server 30. The manifest file 50 lists segments of content streams that have been fully received and segmented at the streaming server 30; the client 40 cannot request a piece content that has not yet been received and segmented by the server.

For instance, if the client 40 renders Segment #1 of Profile #1, and then requests Segment #2 of Profile #2 by consulting the manifest file 50 of the streaming server 30, the streaming server 30 will provide created Segment #2 of Profile #2 accordingly, wherein in case the streaming server 30 would not have aligned the content streams received at its input side, there would be an overlap and the client 40 would render the very last part of Segment #1 before being able of rendering Segment #2 of Profile #2.

Correspondingly, without alignment of segments at the streaming server 30, if the client 40 would want to switch back to Profile #1 for created Segment #3 at BP#7 after having rendered Segment #2, there would be a “gap” in the content rendered at the client 40, and the client 40 would miss out on the very first part of Segment #3 of Profile #1.

Clearly, there is a need for alignment of the different content streams at the streaming server 30 for the client 40 to be able to render the different profiles in a satisfactory manner.

In this particular example, each segment extends over three BPs; for instance Segment #1 extends from BP#1 to BP#4. Typically, segment length is in practice between two and ten seconds. In the following, with reference to the illustration of FIG. 3, a segment will be exemplified to have a length of three seconds, meaning that a BP is interspersed in the streams each second.

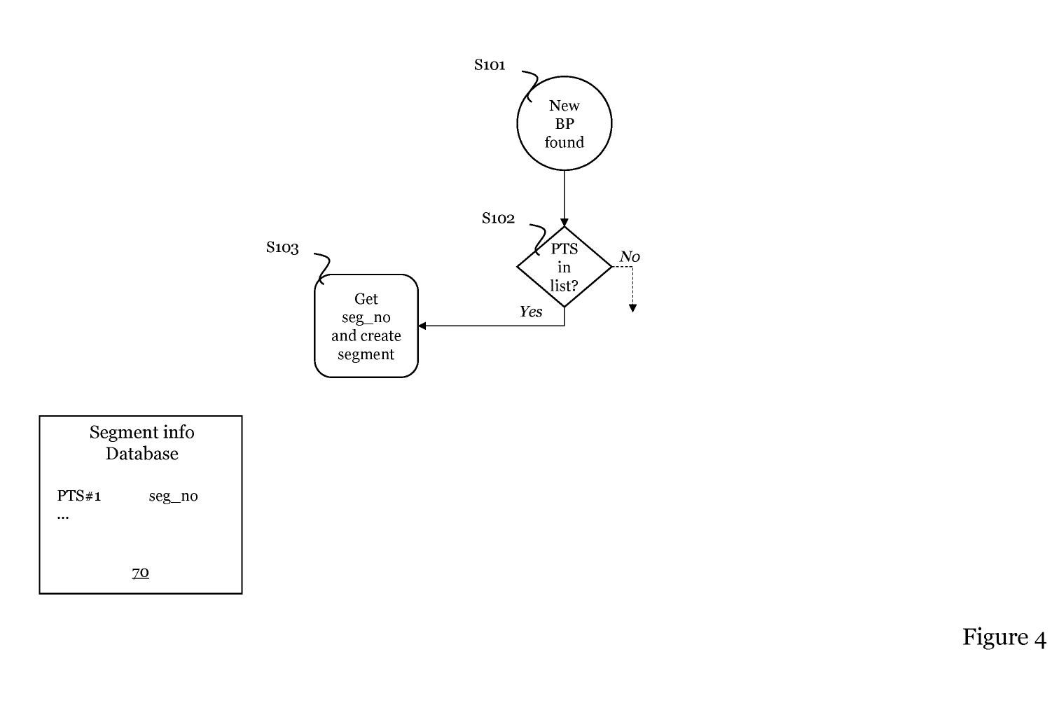

FIG. 4 illustrates a flowchart of a method performed at a streaming server 30 of segmenting at least two received content streams encoded at different bitrates according to an embodiment of the invention.

For each incoming profile, i.e. for each incoming content stream encoded at a particular bitrate, a current BP is identified in step S101 to determine if the stream can be segmented (if it has not already been segmented). As previously mentioned, each BP is associated with a corresponding timestamp (PTS). In this particular example, a segment information database 70 stored at the streaming server 30 initially holds one segment: Segment #1 at PTS#1. That is, segmenting of Profile 1 has been performed by the streaming server 30 to create Segment #1 starting at PTS#1.

Hence, in an embodiment, one of the received streams, in this example Profile #1, is initially segmented at a starting timestamp PTS#1 for creating a segment with which the other received content streams, in this case Profile #2, can be synchronized.

Now, in step S101, BP#1 at PTS#1 is identified for Profile #2 and thereafter, it is determined in step S102 whether a segment identifier is included in the segment information database 70, which identifier designates a segment having a starting point corresponding to the PTS of the identified BP; that is, whether a segment is identified in the segment information database 70 corresponding to PTS#1.

Hence, the streaming server 30 identifies BP#1 at PTS#1 for Profile #2 in step S101 and concludes in step S102 that PTS#1 is in the segment information database 70. The streaming server 30 will thus in step S103 create Segment #1 from the received content stream indicated by Profile #2, i.e. from the received stream a segment is created having the predetermined length extending over three BPs, and the identifier from the segment information database 70 is included with the created segment.

Advantageously, with the embodiment of the method of FIG. 4, Segment #1 of the received content stream Profile #2 is aligned with Segment #1 the received content stream Profile #1.

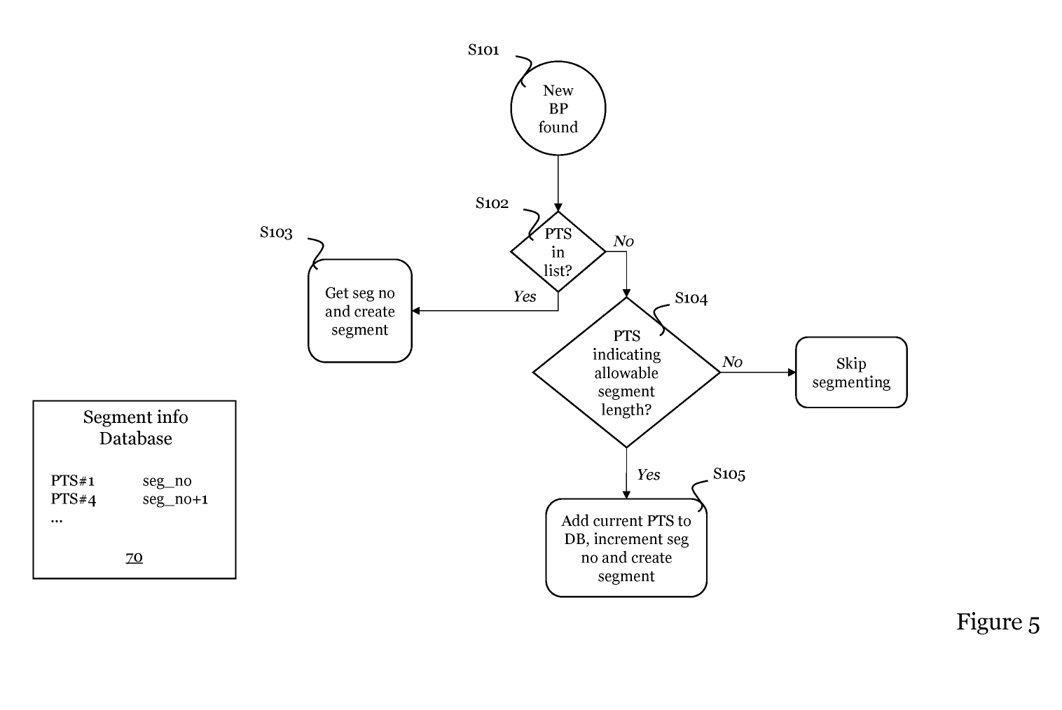

FIG. 5 illustrates a flowchart of a method performed at a streaming server 30 of segmenting at least two received content streams encoded at different bitrates according to a further embodiment of the invention.

The streaming server 30 then proceeds to BP#2 of Profile #1 in step S101, the timestamp PTS#2 of which is not in the manifest file 50 as is concluded in step S102. The streaming server thus proceeds to step S104, where it is determined whether PTS#2 of BP#2 indicates an allowable segment length. For PTS#2, that is not the case, and no segmenting is performed.

The same procedure is performed for BP#2 of Profile #2, with the same result.

Thereafter, the streaming server 30 identifies BP#3 at PTS#3 for Profile #1. Again, PTS#3 is not in the segment information database 70, and further does not indicate an allowable segment length. No segmenting is performed. The same procedure is performed for BP#3 of Profile #2, with the same result.

However, upon identifying BP#4 of Profile #1 at PTS#4 in step S101, and determining that the timestamp PTS#4 is not in the segment information database 70 in step S102, the streaming server 30 proceeds to step S104, where it is determined that PTS#4 of BP#4 indeed indicates an allowable segment length. As a consequence, the streaming server 30 updates the segment information database 70 and creates a new segment, i.e. Segment #2 of Profile #1, in step S105.

In an embodiment, the updating includes adding PTS#4 to the segment information database 70 along with an incremented segment identifier.

Thereafter, upon identifying BP#4 of Profile #2 at PTS#4 in step S101, and determining that the timestamp PTS#4 indeed is in the segment information database 70 in step S102, the streaming server 30 proceeds to step S103, where it creates a new segment, i.e. Segment #2 of Profile #2, and includes the identifier from the segment information database 70 with the created segment.

Advantageously, with the embodiment of the method of FIG. 5, Segment #2 of the received content stream Profile #2 is aligned with Segment #2 the received content stream Profile #1, and so on, as the method proceeds to identifying a next current BP.

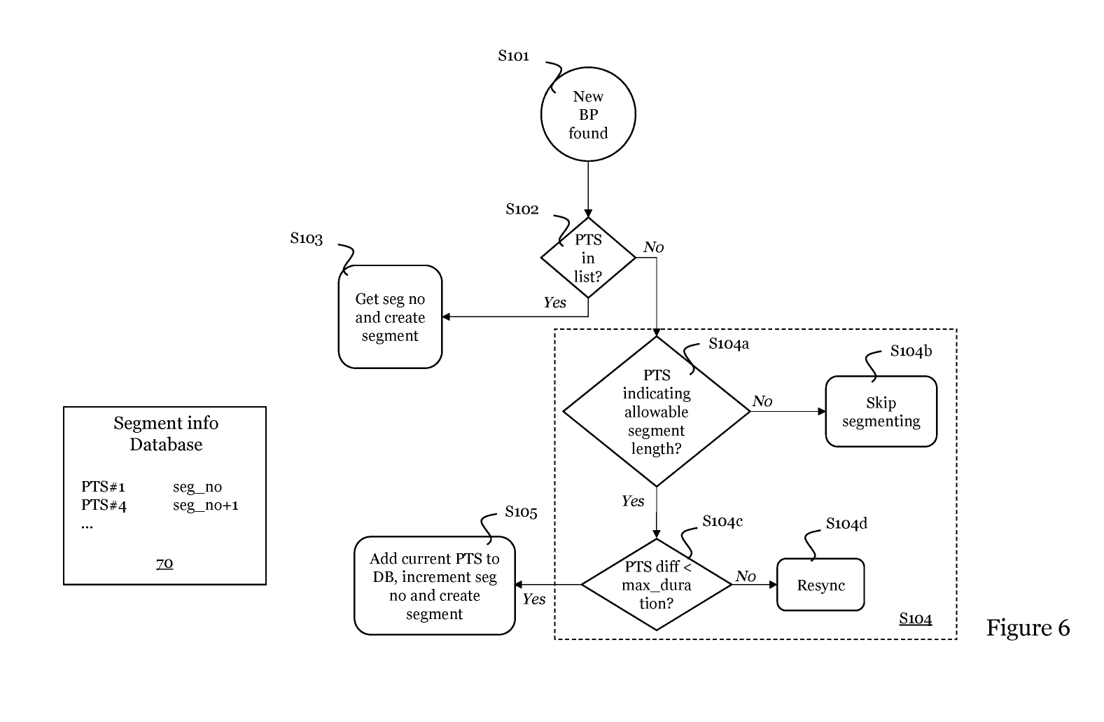

FIG. 6 illustrates a flowchart of a method of a further embodiment of the invention, where when determining whether the PTS of a currently identified BP indicates an allowable segment length or not in step S104, the following is performed.

First, it is determined in step S104a, whether a difference in time between the time stamp PTS of the identified current boundary point BP and a starting point of a closest previously identified segment exceeds a minimum allowable segment length. In the examples given hereinabove, a duration or length of a segment is defined to amount to three seconds. Thus, in case the streams comprise one BP every second, a minimum allowable segment length should exceed a time span covering three BPs, in this particular example a minimum allowable segment length should exceed two seconds.

Using the example of FIG. 5, the streaming server 30 proceeds to BP#2 of Profile #1 in step S101, the timestamp PTS#2 of which is not in the segment information database 70 as is concluded in step S102. The streaming server thus proceeds to step S104a, where it is determined whether the difference between PTS#2 and a starting point of a closest previously identified segment, i.e. PTS#1, exceeds the minimum allowable segment length, which is not the case, and PTS#2 of the identified current boundary point BP#2 is precluded as a possible segmenting point.

Thereafter, the streaming server 30 identifies BP#3 at PTS#3 for Profile #1. Again, PTS#3 is not in the segment information database 70, and further does not indicate an allowable segment length, since PTS#3-PTS#1 <minimum segment length; no segmenting is performed.

However, upon identifying BP#4 of Profile #1 at PTS#4 in step S101, and determining that the timestamp PTS#4 is not in the segment information database 70 in step S102, the streaming server 30 proceeds to step S104a, where it is determined that PTS#4 of BP#4 indeed indicates an allowable segment length, since PTS#4-PTS#1>minimum segment length.

The streaming server 30 optionally proceeds to step S104c, where it determines whether a difference in time between the PTS of the identified current BP and a starting point of a closest previously identified segment is less than a maximum allowable segment length.

In this example, the duration or length of a segment is defined to amount to three seconds. Thus, with the example given with reference to FIG. 3 hereinabove, a maximum allowable segment length should be less than a time span covering five BPs. In this particular example, the maximum allowable segment length should be less than four seconds.

In step S104c, it is determined that PTS#4-PTS#1<maximum segment length, and the streaming server 30 proceeds to step S105 for updating segment information database 70 and creating a new segment, i.e. Segment #2 of Profile #1.

For the sake of discussion, if the currently identified BP would have been BP#5, without BP#4 having been identified previously for Profile #1, the streaming server 30 would have determined in step S104c that BP#5-BP#1 >maximum segment length, and proceeded to step S104d where it would have concluded that synchronization with Profile #1 is lost.

In such a case, in step S104d, the streaming server 30 advantageously re-synchronizes with Profile #1, for instance at BP#7 where Segment #3 is created at a new starting timestamp PTS#7 for creating a segment with which the other received content streams, in this case Profile #2, can be resynchronized.

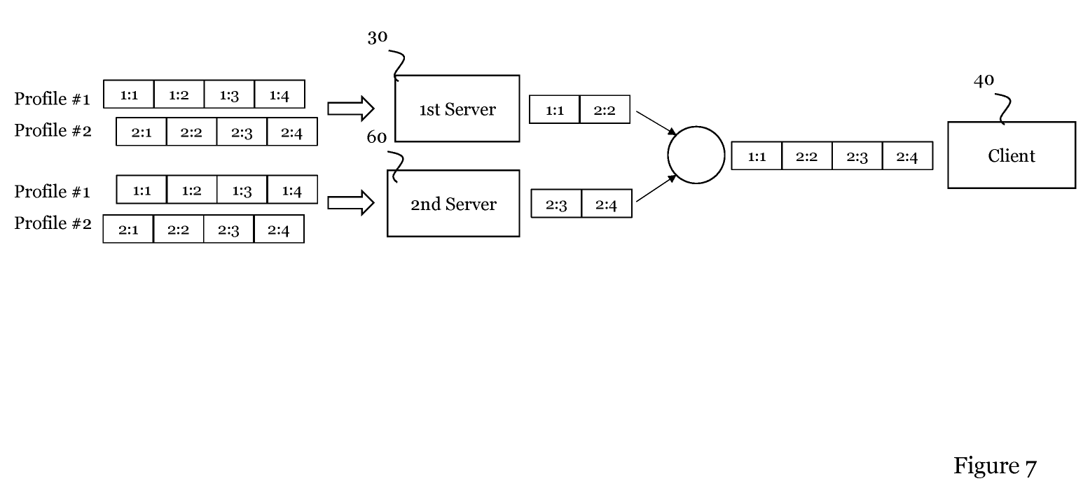

FIG. 7 illustrates a further embodiment of the invention where not only one streaming server 30 is used, but at least one further server 60 for providing the client 40 with requested content.

For redundancy, the same content streams are typically sent to multiple streaming servers 30, 60. In such a scenario, it is then crucial that the segmentation and identification of segments are aligned across the multiple streaming servers, to allow clients to perform failover to another server during a streaming session.

Hence, not only should the segments of each content stream Profile #1, Profile #2 be aligned internally with in each server 30, 60, but further the segments output from the first server 30 should be aligned with those output from the second server 60 in order to provide for the client 40 to switch between segments of the first server 30 and the second server 60.

As is illustrated in FIG. 7, the client 40 will select Segment #1 of Profile #1 (denoted 1:1), followed by Segment #2, Segment #3 and Segment #4 of Profile #2 (denoted 2:2, 2:3 and 2:4, respectively). Since Segment #1 of Profile #1 and Segment #2 of Profile #2 are provided by the first server 30, while Segment #3 of Profile #2 and Segment #4 of Profile #2 are provided by the second server 60, the segments output from the first server 30 should be aligned with those output from the second server 60.

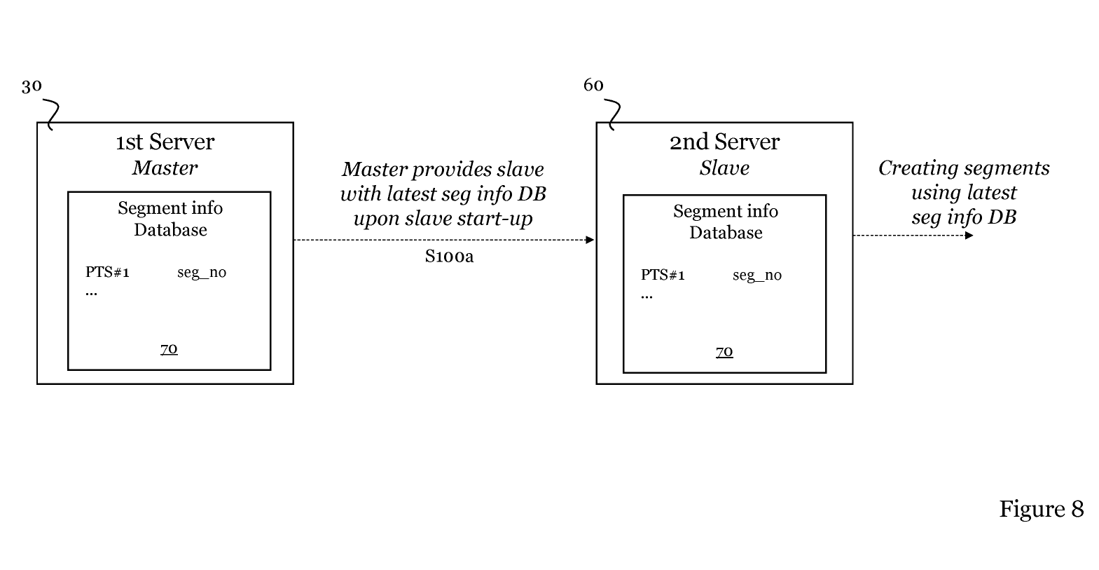

Thus, with reference to FIG. 8, the first server 30 is assigned the task of a master server, while the second server 60 is assigned the task of a slave server. In order to provide alignment of segments output from the two streaming servers 30, 60, the master server 30 provides the slave server with the segment information database 70 in step S201 upon start-up of the slave server 60, or if the slave server 60 requires re-synchronization, which database comprises at least identifiers for created segments and a starting point for each created segment.

The slave server 60 is hence initially synchronized with the master server 30 in that the slave server 60 is provided with the segment information database 70 from which it initially can start creating segments. Thereby, segments of the slave server 60 will advantageously be aligned with the segments of the master server 30, and the client 40 is able to render segments of the different profiles in a satisfactory manner. After the slave server 60 is provided with the segment information database 70, it will proceed with creating segments as has been discussed in detail hereinabove with reference to FIGS. 3-6.

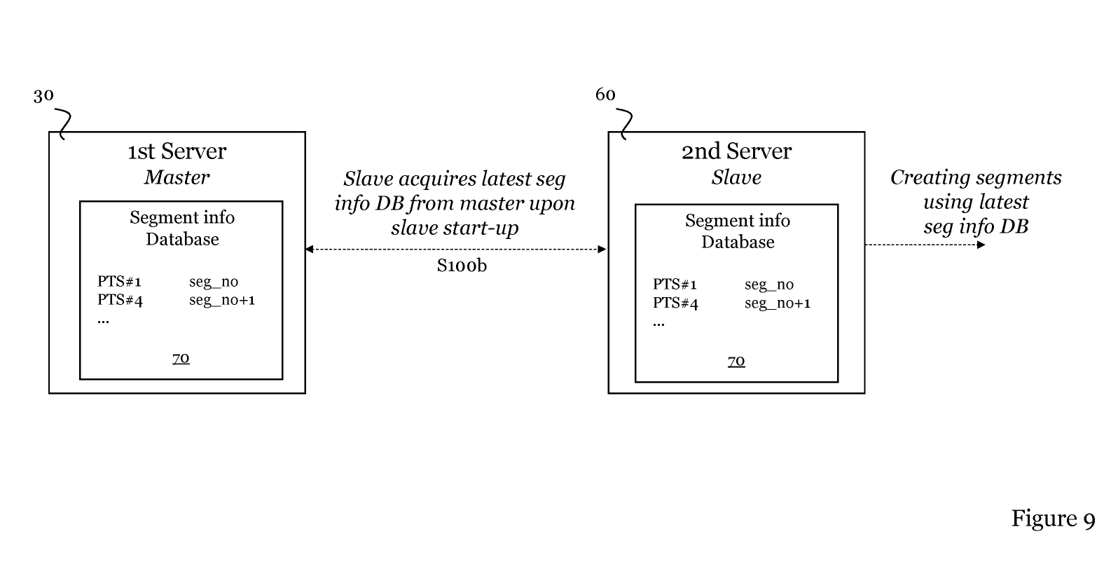

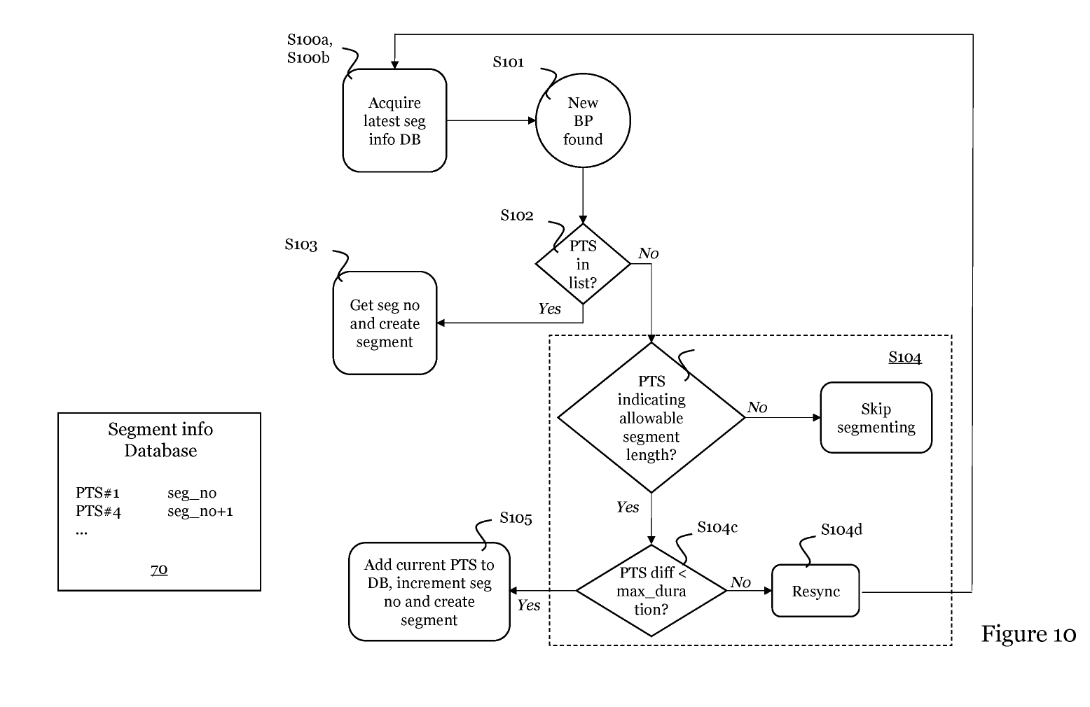

Alternatively, with reference to FIG. 9, the master server 60 requests the segment information database 70 from the master server 30 in step S301 at start-up of the slave server 60, or if re-synchronization of the slave server 60 is required. As in the embodiment of FIG. 8, the slave server 60 is initially synchronized with the master server 30 in that the slave server 60 is provided with the segment information database 70 from which it initially can start creating segments, and as a result the segments of the slave server 60 will advantageously be aligned with the segments of the master server 30, and the client 40 is able to render segments of the different profiles in a satisfactory manner.

FIG. 9 illustrates the method of the embodiment of the invention previously discussed with reference to FIG. 6, but where the acquiring of the segment information database 70 the slave server 60 further is included. Reference is further made to the example illustrated in FIG. 3.

Hence, upon start-up of the slave server 60, the current segment information database 70 is transferred from the master server 30 to the slave server 60, either by the slave server 60 requesting the database (S100b), or the master server 30 being configured to provide the database 70 to the slave server (S100a) upon start-up of the slave server 60.

Now, in step S101, BP#1 at PTS#1 is identified for Profile #2 and thereafter, it is determined in step S102 whether a segment identifier is included in the segment information database 70, which identifier designates a segment having a starting point corresponding to the PTS of the identified BP; that is, whether a segment is identified in the segment information database 70 corresponding to PTS#1.

Hence, the slave server 60 identifies BP#1 at PTS#1 for Profile #2 in step S101 and concludes in step S102 that PTS#1 is in the segment information database 70. The slave server 60 will thus in step S103 create Segment #1 from the received content stream indicated by Profile #2, i.e. from the received stream a segment is created having the predetermined length extending over three BPs, and the identifier from the segment information database 70 is included with the created segment.

The slave server 60 proceeds to BP#2 of Profile #1 in step S101, the timestamp PTS#2 of which is not in the segment information database 70 as is concluded in step S102. The slave server 60 thus proceeds to step S104a, where it is determined whether the difference between PTS#2 and a starting point of a closest previously identified segment, i.e. PTS#1, exceeds the minimum allowable segment length, which is not the case, and PTS#2 of the identified current boundary point B#2 is precluded as a possible segmenting point in step S104b.

Thereafter, the streaming server 30 identifies BP#3 at PTS#3 for Profile #1 in step S101. Again, PTS#3 is not in the segment information database 70 as concluded in step S102, and further does not indicate an allowable segment length in step S104a, since PTS#3-PTS#1<minimum segment length; no segmenting is performed, step S104b.

However, upon identifying BP#4 of Profile #1 at PTS#4 in step S101, and determining that the timestamp PTS#4 is not in the segment information database 70 in step S102, the slave server 60 proceeds to step S104a, where it is determined that PTS#4 of BP#4 indeed indicates an allowable segment length, since PTS#4-PTS#1>minimum segment length.

The slave server 60 optionally proceeds to step S104c, where it determines whether a difference in time between the PTS of the identified current BP and a starting point of a closest previously identified segment is less than a maximum allowable segment length.

In this example, the duration or length of a segment is defined to amount to three seconds, with BPs occurring each second. Thus, a maximum allowable segment length should be less than four seconds.

In step S104c, it is determined that PTS#4-PTS#1<maximum segment length, and the slave server 60 proceeds to step S105 for updating segment information database 70 and creating a new segment, i.e. Segment #2 of Profile #1.

Hence, by acquiring the current segment information database from the master server 30, the created segments of the slave server 60 will advantageously be aligned with those of the master server 30.

However, if the currently identified BP would have been BP#5, without BP#4 having been identified previously for Profile #1, the slave server 60 would have determined in step S104c that BP#5-BP#1>maximum segment length, and proceeded to step S104d where it would have concluded that synchronization with Profile #1 is lost.

In such a case, in step S104d, the slave server 60 advantageously acquires a more current segmentation database 70 from the master server 30, and the slave server 60 is advantageously resynchronized with the master server 30. The process of the slave server 60 thereafter commences again at step S101.

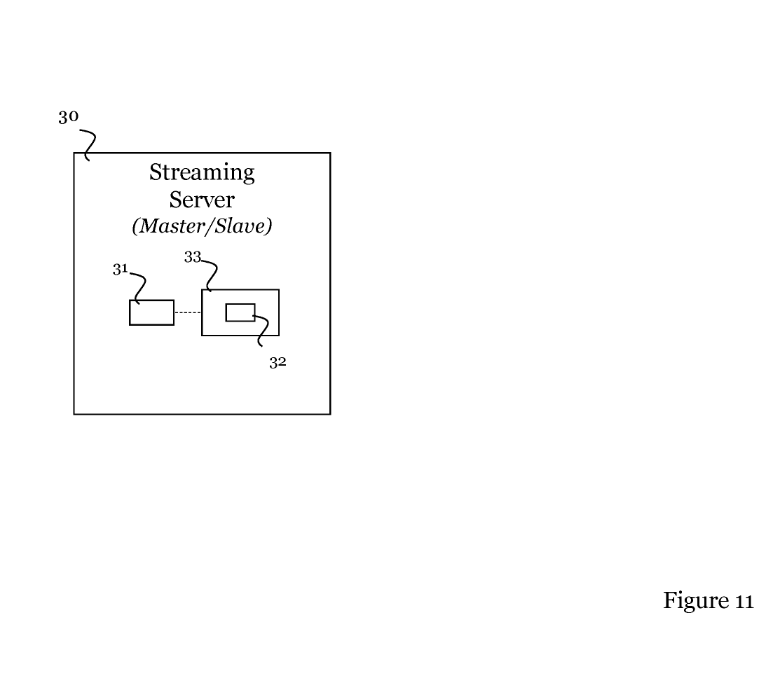

With reference to FIG. 11, the steps of the methods performed by the streaming server 30 according to embodiments of the invention, be it a master server or a slave server as described hereinabove, are in practice performed by a processing unit 31 embodied in the form of one or more microprocessors arranged to execute a computer program 32 downloaded to a suitable storage medium 33 associated with the microprocessor, such as a Random Access Memory (RAM), a Flash memory or a hard disk drive. The processing unit 31 is arranged to cause the streaming server 30 to carry out the method according to embodiments of the present invention when the appropriate computer program 32 comprising computer-executable instructions is downloaded to the storage medium 33 and executed by the processing unit 31. The storage medium 33 may also be a computer program product comprising the computer program 32. Alternatively, the computer program 32 may be transferred to the storage medium 33 by means of a suitable computer program product, such as a Digital Versatile Disc (DVD) or a memory stick. As a further alternative, the computer program 32 may be downloaded to the storage medium 33 over a network. The processing unit 31 may alternatively be embodied in the form of a digital signal processor (DSP), an application specific integrated circuit (ASIC), a field-programmable gate array (FPGA), a complex programmable logic device (CPLD), etc.

The invention has mainly been described above with reference to a few embodiments. However, as is readily appreciated by a person skilled in the art, other embodiments than the ones disclosed above are equally possible within the scope of the invention, as defined by the appended patent claims.

1-33. (canceled)

34. A method performed at a streaming server (30) of segmenting at least two received content streams, comprising:
identifying (S101) a current boundary point for each of the at least two received content streams indicating where the respective content stream can be segmented;
determining (S102) whether an identifier for a segment is included in a segment information database (70) at the streaming server (30), the identified segment having a starting point corresponding to a timestamp of the identified current boundary point; and if so:
segmenting (S103) the received content stream, for which the segment identifier was included in the segment information database (70), at said timestamp and including the segment identifier with the segmented stream.

35. The method of claim 34, further comprising, in case no identified segment in the segment information database (70) has a starting point corresponding to a timestamp of the identified current boundary point:
determining (S104) whether the timestamp of the identified current boundary point indicates an allowable segment length; and if so
segmenting (S105) the received content stream, for which the segment length is indicated to be allowable, at said timestamp and including the segment identifier with the segmented stream, and updating the segment information database (70).

36. The method of claim 35, the updating of the segment information database (70) comprising:
adding an incremented segment identifier and setting a starting point of the segment corresponding to the incremented identifier to the time stamp of the identified current boundary.

37. The method of claim 35, the determining (S104) whether the timestamp of the identified current boundary point indicates an allowable segment length further comprising:
determining (S104a) whether a difference in time between the time stamp of the identified current boundary point and a starting point of a closest previously identified segment exceeds a minimum allowable segment length; and if not
precluding (S104b) the time stamp of the identified current boundary point as a possible segmenting point.

38. The method of claim 37, further comprising, in case the difference in time between the timestamp of the identified current boundary point and a starting point of a closest previous identified segment exceeds a minimum allowable segment length:
determining (S104c) whether a difference in time between the timestamp of the identified boundary point and a starting point of a closest previously identified segment is less than a maximum allowable segment length; and if not
resynchronizing (S104d) to one of the received content streams.

39. The method of claim 34, wherein one of the at least two received content streams initially is segmented at a starting timestamp for creating a segment with which the other received content streams can be synchronized.

40. The method of claim 34, further comprising:
providing (S100a) a slave server (60) with a current segment information database (70) comprising at least an identifier for a segment and a starting point for each identified segment, wherein created segments of received content streams are aligned with segments of received content streams created by the slave server (60).

41. A method performed at a slave server (60) of aligning created segments of received content streams with segments of the received content streams created by a master server (30), comprising:
acquiring (S100b), from the master server (30), a current segment information database (70) comprising at least an identifier for a segment and a starting point for each identified segment.

42. A streaming server (30) configured to segment at least two received content streams, which streaming server (30) comprises a processing unit (31) arranged to cause the streaming server (30) to be operative to:
identify a current boundary point for each of the at least two received content streams indicating where the respective content stream can be segmented;
determine whether an identifier for a segment is included in a segment information database (70) at the streaming server (30), the identified segment having a starting point corresponding to a timestamp of the identified current boundary point; and if so:
segment the received content stream, for which the segment identifier was included in the segment information database (70), at said timestamp and including the segment identifier with the segmented stream.

43. The streaming server (30) of claim 42, further being operative to, in case no identified segment in the segment information database (70) has a starting point corresponding to a timestamp of the identified current boundary point:
determine whether the timestamp of the identified current boundary point indicates an allowable segment length; and if so
segment the received content stream, for which the segment length is indicated to be allowable, at said timestamp and including the segment identifier with the segmented stream, and updating the segment information database (70).

44. The streaming server (30) of claim 43, further being operative to, when updating the segment information database (70):
add an incremented segment identifier and setting a starting point of the segment corresponding to the incremented identifier to the time stamp of the identified current boundary.

45. The streaming server (30) of claim 43, further being operative to, when determining whether the timestamp of the identified current boundary point indicates an allowable segment length:
determine whether a difference in time between the time stamp of the identified current boundary point and a starting point of a closest previously identified segment exceeds a minimum allowable segment length; and if not
preclude the time stamp of the identified current boundary point as a possible segmenting point.

46. The streaming server (30) of claim 45, further being operative to, in case the difference in time between the timestamp of the identified current boundary point and a starting point of a closest previous identified segment exceeds a minimum allowable segment length:
determine whether a difference in time between the timestamp of the identified boundary point and a starting point of a closest previously identified segment is less than a maximum allowable segment length; and if not
resynchronize to one of the received content streams.

47. The streaming server (30) of claim 42, further being operative to initially segment one of the at least two received content streams at a starting timestamp for creating a segment with which the other received content streams can be synchronized.

48. The streaming server (30) of claim 42, further being operative to:
provide a slave server (60) with a current segment information database (70) comprising at least an identifier for a segment and a starting point for each identified segment, wherein created segments of received content streams can be aligned with segments of received content streams created by the slave server (60).

49. A slave server (60) configured to align created segments of received content streams with segments of the received content streams created by a master server (30), which slave server (60) comprises a processing unit (31) arranged to cause the slave server (60) to be operative to:
acquire, from the master server (30), a current segment information database (70) comprising at least an identifier for a segment and a starting point for each identified segment.

50. The slave server (60) of claim 49 further being operative to:
identify a current boundary point for each of the at least two received content streams indicating where the respective content stream can be segmented;
determine whether an identifier for a segment is included in the segment information database (70), the identified segment having a starting point corresponding to a timestamp of the identified current boundary point; and if so:
segment the received content stream, for which the segment identifier was included in the segment information database (70), at said timestamp and including the segment identifier with the segmented stream.

51. The slave server (30) of claim 50, further being operative to, in case no identified segment in the segment information database (70) has a starting point corresponding to a timestamp of the identified current boundary point:
determine whether the timestamp of the identified current boundary point indicates an allowable segment length; and if so
segment the received content stream, for which the segment length is indicated to be allowable, at said timestamp and including the segment identifier with the segmented stream, and updating the segment information database (70).

52. The slave server (60) of claim 51, further being operative to, when updating the segment information database (70):
add an incremented segment identifier and setting a starting point of the segment corresponding to the incremented identifier to the time stamp of the identified current boundary.

53. The slave server (60) of claim 51, further being operative to, when determining whether the timestamp of the identified current boundary point indicates an allowable segment length:
determine whether a difference in time between the time stamp of the identified current boundary point and a starting point of a closest previously identified segment exceeds a minimum allowable segment length; and if not
preclude the time stamp of the identified current boundary point as a possible segmenting point.

54. The slave server (60) of claim 53, further being operative to, in case the difference in time between the timestamp of the identified current boundary point and a starting point of a closest previous identified segment exceeds a minimum allowable segment length:
determine whether a difference in time between the timestamp of the identified boundary point and a starting point of a closest previously identified segment is less than a maximum allowable segment length; and if not
resynchronize to one of the received content streams.
